(19) United States
(12) Patent Application Publication
(10) Pub. No.: US 2012/0317270 A1
(43) Pub. Date: Dec. 13, 2012

(54) INTELLIGENT PRESENCE COST MANAGEMENT BASED UPON CONGESTION STATUS AND SUBSCRIBER PROFILE

(75) Inventors: Mira Vrbaski, Kanata (CA); Colin L. Kahn, Morris Plains, NJ (US); Mark A. Smith, Jersey City, NJ (US); Edward Grinshpun, Freehold, NJ (US); Sankaranarayanan Sathyanarayan, Stewartsville, NJ (US)

(73) Assignees: Alcatel-Lucent USA Inc.; Alcatel-Lucent Canada Inc.

(21) Appl. No.: 13/157,888

(22) Filed: Jun. 10, 2011

(51) Int. Cl. G06F 15/173

(52) U.S. Cl. 709/224

(57) ABSTRACT

Various exemplary embodiments relate to a method performed by a network platform, the method comprising: receiving a subscriber ID and associated base station ID and application IDs from a user equipment; receiving network congestion information from a network monitor; identifying an application affected by the network congestion; calculating a cost to the identified application due to the network congestion; and notifying the identified application of the calculated cost.

### TECHNICAL FIELD

Various exemplary embodiments disclosed herein relate generally to the costs related to using applications on a wireless network in the presence of network congestion.

### BACKGROUND

As the demand increases for varying types of applications within mobile telecommunications networks, service providers must constantly upgrade their systems in order to reliably provide this expanded functionality. This increased functionality along with an increased number of users may lead to network congestion. This network congestion may lead to increased cost to applications used by a subscriber.

### SUMMARY

In mobile telecommunication systems applications have a limited ability to determine if network congestions is affecting the performance and cost of providing the application to a subscriber. Accordingly, it would be desirable to provide the application with a cost due to network congestion. Such cost information may be used by the application to operate differently or to seek other less congested paths to provide application services to the subscriber.

In light of the present need for determining the cost of network congestion to applications in the wireless network, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a network platform, the method including: receiving a subscriber ID and associated base station ID and application IDs from a user equipment; receiving network congestion information from a network monitor; identifying an application affected by the network congestion; calculating a cost to the identified application due to the network congestion; and notifying the identified application of the calculated cost.

A further exemplary embodiment relates to a congestion cost system for a wireless communication system, including: a network congestion monitoring element that produces network congestion information; a network platform that receives the network congestion information from the network congestion monitoring element and that receives a subscriber ID and associated base station ID and application IDs from a user equipment; wherein the network platform is configured to: identify an application affected by the network congestion; calculate a cost to the identified application due to the network congestion; and notify the identified application of the calculated cost.

A further exemplary embodiment relates to A tangible and non-transitory machine-readable storage medium encoded with instructions for a method performed by a network platform, the machine-readable storage medium including: instructions for receiving a subscriber ID and associated base station ID and application IDs from a user equipment; instructions for receiving network congestion information from a network monitor; instructions for identifying an application affected by the network congestion; instructions for calculating a cost to the identified application due to the network congestion; and instructions for notifying the identified application of the calculated cost.

Various embodiments may be further adapted wherein the network congestion information includes a congestion level indication.

Various embodiments may further include the network congestion information includes an application ID.

Various embodiments may be further adapted wherein the network congestion includes a congested base station.

Various embodiments may be further adapted wherein the network congestion information includes a congested base station ID.

Various embodiments may be further adapted wherein identifying an application affected by the network congestion includes identifying all applications associated with the congested base station ID.

Various embodiments may further include receiving additional network congestion information from the network monitor for the identified application; calculating a cost to the identified application due to the additional network congestion information; and notifying the identified application of the cost due to the additional network congestion information.

Various embodiments may be further adapted wherein the network congestion information includes a plurality of application IDs, further including repeating the steps of calculating a cost and notifying the identified application for each of the plurality of the identified applications.

### BRIEF DESCRIPTION OF THE DRAWINGS

In order to better understand various exemplary embodiments, reference is made to the accompanying drawings, wherein:

FIG. 1 illustrates an exemplary subscriber network for providing various data services; and

FIG. 2 illustrates an exemplary method for providing cost information to an application due to network congestion.

### DETAILED DESCRIPTION

Referring now to the drawings, in which like numerals refer to like components or steps, there are disclosed broad aspects of various exemplary embodiments.

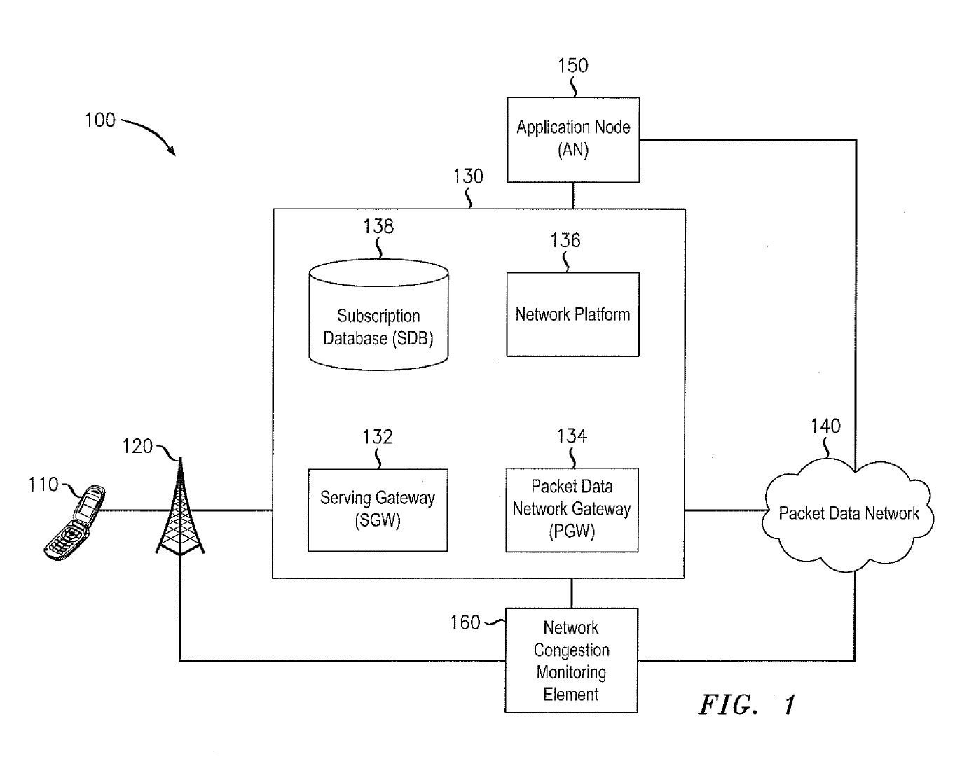

FIG. 1 illustrates an exemplary subscriber network 100 for providing various data services. Exemplary subscriber network 100 may be a telecommunications network or other network for providing access to various services. Exemplary subscriber network 100 may include user equipment 110, base station 120, packet core network 130; packet data network 140, application node (AN) 150, and network congestion monitoring element 160.

User equipment 110 may be a device that communicates with packet data network 140 for providing the end-user with a data service. Such data service may include, for example, voice communication, text messaging, multimedia streaming, and Internet access. More specifically, in various exemplary embodiments, user equipment 110 is a personal, tablet, or laptop computer, wireless email device, cell phone, e-reader, television set-top box, or any other device capable of communicating with other devices via packet core network 130.

Base station 120 may be a device that enables communication between user equipment 110 and packet core network 130. For example, base station 120 may be a base transceiver station such as an evolved nodeB (eNodeB) as defined by 3GPP standards. The base station 120 may also be part of a GPRS/EDGE network, a WCDMA network, a 3G1X/EV-DO network, a HSPA/HSPA+ network, or another wireless communication network. Thus, base station 120 may be a device that communicates with user equipment 110 via a first medium, such as radio waves, and communicates with packet core network 130 via a second medium, for example, an Ethernet cable. Base station 120 may be in direct communication with packet core network 130 or may communicate via a number of intermediate nodes (not shown). In various embodiments, multiple adjacent base stations may also be present to provide mobility to user equipment 110.

Packet core network 130 may be a device or network of devices that provides user equipment 110 with gateway access to packet data network 140. Packet core network 130 may further charge a subscriber for use of provided data services and ensure that particular quality of experience (QoE) standards are met. Thus, packet core network 130 may be implemented, at least in part, according to the 3GPP TS 29.212, 29.213, 29.214, 23.401, and 23.402 standards among others. The packet core network 130 may additionally or alternatively be implemented according to other standards as well. Accordingly, packet core network 130 may include a serving gateway (SGW) 132, a packet data network gateway (PGW) 134, network platform 136, and a Home Subscriber System/Subscriber Profile Repository (HSS/SPR) 138.

Serving gateway (SGW) 132 may be a device that provides gateway access to the packet core network 130. SGW 132 may be the first device within the packet core network 130 that receives packets sent by user equipment 110. SGW 132 may forward such packets toward PGW 134. SGW 132 may perform a number of functions such as, for example, managing mobility of user equipment 110 between multiple base stations, and enforcing particular quality of service (QoS) characteristics for each flow being served. In various implementations, such as those implementing the Proxy Mobile IP standard, SGW 132 may include a Bearer Binding and Event Reporting Function (BBERF). In various exemplary embodiments, packet core network 130 may include multiple SGWs (not shown) and each SGW may communicate with multiple base stations (not shown).

Packet data network gateway (PGW) 134 may be a device that provides gateway access to packet data network 140. PGW 134 may be the final device within the packet core network 130 that receives packets sent by user equipment 110 toward packet data network 140 via SGW 132. PGW 134 may include a number of additional features such as, for example, packet filtering, deep packet inspection, and subscriber charging support. PGW 134 may also be responsible for requesting resource allocation for unknown application services.

The network platform 136 may be a device that receives requests for application services, generates rules and policies regarding the operation of the packet core network 130. The network platform 136 may also be in communication with SGW 132 and PGW 134. The network platform 136 may also receive network congestion information. The network platform 136 may use the network congestion information to calculate a cost to applications affected by the network congestion. This will be described in further detail below. The network platform 136 may be or include a policy and charging rules function (PCRF).

Home Subscriber System/Subscriber Profile Repository (HSS/SPR) 138 may be a device that stores information related to subscribers to the subscriber network 100. Thus, HSS/SPR 138 may include a machine-readable storage medium such as read-only memory (ROM), random-access memory (RAM), magnetic disk storage media, optical storage media, flash-memory devices, and/or similar storage media. HSS/SPR 138 may be a component of network platform 136 or may constitute an independent node within packet core network 130. Data stored by HSS/SPR 138 may include an identifier of each subscriber, an ID for an associated base station, application IDs for applications used by the subscriber, and indications of subscription information for each subscriber such as bandwidth limits, charging parameters, and subscriber priority.

Packet data network 140 may be any network for providing data communications between user equipment 110 and other devices connected to packet data network 140, such as AN 150. Packet data network 140 may further provide, for example, phone and/or Internet service to various user devices in communication with packet data network 140.

Application node (AN) 150 may be a device that provides a known application service to user equipment 110. Thus, AN 150 may be a server or other device that provides, for example, a video streaming service, music streaming service, gaming service, or voice communication service to user equipment 110. AN 150 may further be in communication with the network platform 136 of the packet core network 130. When AN 150 is to begin providing known application service to user equipment 110, AN 150 may generate an application request message to notify the network platform 136 that resources should be allocated for the application service. This application request message may include information such as an identification of the subscriber using the application service and an identification of the particular service data flows that must be established in order to provide the requested service. AN 150 may communicate such an application request to the platform network 136.

The network congestion monitoring element 160 may analyze the network capacity and usage of the base stations 120, including the capacity available on the air-interface between the base station 120 and the user equipment 110 or any other network link used to provide the application to the user equipment 110. If the base station 120 or any other network link reaches a predetermined level of congestion, then the network congestion monitoring element 160 may provide network congestion information to the network platform 136. The network congestion information may further include a congestion level indication that may provide an indication as to the severity of the congestion at the base station 120 or on a network link. In addition, the message may contain a list of user equipments that are contributing to the network congestion. The network congestion monitoring element 160 may be implemented as software on a server or other processor, as a router, as a gateway, or as any other hardware or software capable of providing this functionality.

Having described the components of subscriber network 100, a brief summary of the operation of subscriber network 100 will be provided. It should be apparent that the following description is intended to provide an overview of the operation of subscriber network 100 and is therefore a simplification in some respects.

According to various exemplary embodiments, user equipment 110 may communicate with network platform 136 to provide a subscriber ID, a base station ID for the base station 160 currently connected to the user equipment 110 as well as application IDs for applications currently used by the user equipment 110. The network platform 136 may then store the subscriber ID, base station ID, and application IDs associated with the user equipment 110 in the HSS/SPR 138. The subscriber ID, base station ID, and application IDs associated with the user equipment 110 may also be provided by other network equipment and stored in the HSS/SPR 138.

The network congestion monitoring element 160 may monitor the traffic at the base station 120 or in the wireless network to determine if the base station 120 or the wireless network is congested. The network congestion monitoring element 160 may use various methods and parameters to identify congestion at the base station 120 or in the network, for example used or available bandwidth. When the congestion exceeds a threshold value, the congestion monitoring element 160 may send network congestion information to the network platform 136 to indicate network congestion. Further, the network congestion monitoring element 160 may determine a level of congestion present based upon predetermined criteria and provide a congestion level indication in the network congestion information. Furthermore, the network congestion monitoring element 160 may report a list of subscriber/user equipments that are contributing to the congestion, including a full list or delta list from previous notifications as well as other description characteristics of the congested network element. Also, the congestion monitoring element 160 may provide application IDs of applications using a congested network link. For example, the congestion monitoring element 160 may perform deep packet inspection on packets on a congested link to determine the application ID.

When the network platform 136 receives the network congestion information, the network platform 136 determines if any subscribers found in the HSS/SPR 138 are currently using the congested base station 120 or network link or are otherwise affected by the network congestion. If the base station 120 is congested, then all of the applications associated with user equipments 110 connected to the base station 110 will be subject to congestion. The application IDs of these applications are determined. Also, if a network link is experiencing congestion, then the network congestion information may include application IDs of applications affected by the congested network link. The network congestion information may include information indicating the level of congestion. Further, network platform 136 may be able to identify applications affected by network link or base station congestion based upon a knowledge of the network topology and the requirements of applications.

Once the network platform 136 has a list of application IDs for applications affected by network congestion, the network platform 136 may calculate a cost to the application of the network congestion. Such cost may be based upon the level of congestion, subscriber agreement information, the cost of bandwidth based upon usage, time of day, etc., or other factors. The cost may actually be calculated based upon a currency value or may simply be a numeric metric that will, for example, allow for comparison to thresholds and other values. This cost value may then be sent to the application affected by the network congestion. The application may then decide whether to change its behavior. For example, an application performing a download of data that is not time sensitive may choose to delay the download until the congestion is relieved and hence the cost is lower. In another example, a streaming application may decide to use a lower bit rate to stream content at a lower quality to avoid excessive cost or delay due to congestion. Applications may use the cost in many other ways to modify operational behavior in response to congestion.

As any specific network congestion may affect numerous applications, the network platform 136 will identify all such applications and calculate a cost for each application, and then send the cost information to the application. Further, as the network congestion changes, updated network congestion information may be received. This updated network congestion information may be used to calculate an updated cost value for each application affected by the network congestion.

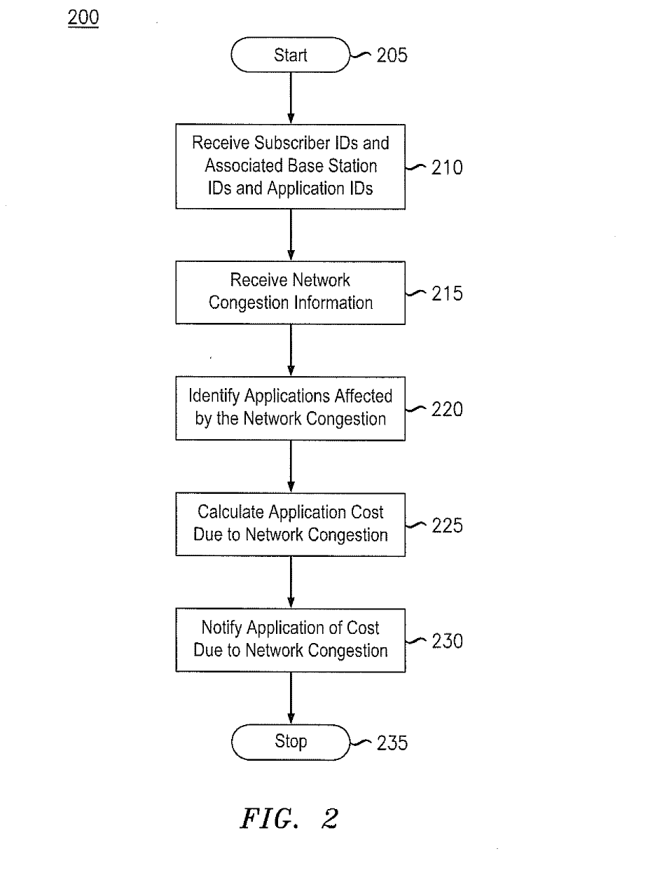

FIG. 2 illustrates an exemplary method for providing cost information to an application due to network congestion. The method 200 begins at step 205. Next, at step 210 the network platform 136 receives subscriber IDs and associated base station IDs and application IDs. At step 215 the network platform receives network congestion information. As described above, such network congestion information may include information regarding a congested base station 120 or a congested network link. Also, the network congestion information may include information indicating the level of congestion or application IDs of applications affected by the network congestion. Next, at step 220, the network platform identifies applications affected by the network congestion. Then at step 225, the network platform 136 calculates the application cost of the identified applications due to the network congestion. Next, at step 230, the network platform 136 notifies the application of the cost due to the network congestion. The method 200 then ends at step 235.

It should be apparent from the foregoing description that various exemplary embodiments of the invention may be implemented in hardware and/or firmware. Furthermore, various exemplary embodiments may be implemented as instructions stored on a tangible and non-transitory machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method performed by a network platform, the method comprising:
receiving a subscriber ID and associated base station ID and application IDs from a user equipment;
receiving network congestion information from a network monitor;
identifying an application affected by the network congestion;
calculating a cost to the identified application due to the network congestion; and
notifying the identified application of the calculated cost.

2. The method of claim 1, wherein the network congestion information includes a congestion level indication.

3. The method of claim 1, wherein the network congestion information includes an application ID.

4. The method of claim 1, wherein the network congestion includes congestion at a base station.

5. The method of claim 4, wherein the network congestion information includes a congested base station ID.

6. The method of claim 5, wherein identifying an application affected by the network congestion includes identifying all applications associated with the congested base station ID.

7. The method of claim 1, further comprising:
receiving additional network congestion information from the network monitor for the identified application;
calculating a cost to the identified application due to the additional network congestion information; and
notifying the identified application of the cost due to the additional network congestion information.

8. The method of claim 1, wherein the network congestion information includes a plurality of application IDs, further comprising repeating the steps of calculating a cost and notifying the identified application for each of the plurality of the identified applications.

9. A congestion cost system for a wireless communication system, comprising:
a network congestion monitoring element that produces network congestion information;
a network platform that receives the network congestion information from the network congestion monitoring element and that receives a subscriber ID and associated base station ID and application IDs from a user equipment;
wherein the network platform is configured to:
identify an application affected by the network congestion;
calculate a cost to the identified application due to the network congestion; and
notify the identified application of the calculated cost.

10. The system of claim 9, the network congestion information includes a congestion level indicator.

11. The system of claim 10, wherein the network congestion information includes an application ID.

12. The system of claim 9, wherein the network congestion includes congestion at a base station.

13. The system of claim 12, wherein identifying an application affected by the network congestion includes identifying all applications associated with the congested base station ID.

14. A tangible and non-transitory machine-readable storage medium encoded with instructions for a method performed by a network platform, the machine-readable storage medium comprising:
instructions for receiving a subscriber ID and associated base station ID and application IDs from a user equipment;
instructions for receiving network congestion information from a network monitor;
instructions for identifying an application affected by the network congestion;
instructions for calculating a cost to the identified application due to the network congestion; and
instructions for notifying the identified application of the calculated cost.

15. The tangible and non-transitory machine-readable storage medium of claim 14, wherein the network congestion information includes a congestion level indication.

16. The tangible and non-transitory machine-readable storage medium of claim 14, wherein the network congestion information includes an application ID.

17. The tangible and non-transitory machine-readable storage medium of claim 14, wherein the network congestion includes congestion at a base station.

18. The tangible and non-transitory machine-readable storage medium of claim 17, wherein the network congestion information includes a congested base station ID.

19. The tangible and non-transitory machine-readable storage medium of claim 18, wherein the instructions for identifying an application affected by the network congestion includes identifying all applications associated with the congested base station ID.

20. The tangible and non-transitory machine-readable storage medium of claim 19, further comprising:
instructions for receiving additional network congestion information from the network monitor for the identified application;
instructions for calculating a cost to the identified application due to the additional network congestion information; and
instructions for notifying the identified application of the cost due to the additional network congestion information.

21. The tangible and non-transitory machine-readable storage medium of claim 14, wherein the network congestion information includes a plurality of application IDs, further comprising instructions for repeating the instructions for calculating a cost and the instructions for notifying the identified application for each of the plurality of the identified applications.
